(19) United States
(12) Patent Application Publication
(10) Pub. No.: US 2007/0178293 A1
(43) Pub. Date: Aug. 2, 2007

(54) Super Lattice Intrinsic Materials

(76) Inventors: Steven C. Yerkes, Escondido, CA (US); James M. Horne, San Diego, CA (US)

Correspondence Address: FISH & RICHARDSON, PC, P.O. BOX 1022, MINNEAPOLIS, MN, 55440-1022, US

(21) Appl. No.: 11/620,983

(22) Filed: Jan. 8, 2007

Related U.S. Application Data
(60) Provisional application No. 60/757,104, filed on Jan. 6, 2006.

(51) Int. Cl. A01K 1/015

(52) U.S. Cl. 428/221

(57) ABSTRACT

In an exemplary embodiment, a Super Lattice Intrinsic Material utilizes a coupling of an appropriate micro/macro structured substrate and a group of as-deposited nanostructures. Substrate texture can be provided either by prior or insitu processing, and the material depositions can be either uniform or non-uniform depending on the desired product parameters.

### REFERENCE TO PRIORITY DOCUMENT

This application claims priority of co-pending U.S. Provisional Patent Application Ser. No. 60/757,104, filed Jan. 6, 2006. Priority of the aforementioned filing date is hereby claimed and the disclosure of the Provisional Patent Application is hereby incorporated by reference in its entirety.

### BACKGROUND AND SUMMARY

The present disclosure relates to a material having an artificial complex permittivity and complex permeability, wherein the material has unique device properties over wide electromagnetic energy bandwidths. The material incorporates a combination of substrate macro/micro structure either prior to insertion into a processing chamber or insitu substrate texturing, coupled with nanostructures imparted onto a device via the deposition process. The subsequent devices manufactured using the materials described herein can generally be produced in large volumes at a reasonable cost.

There are a variety of technologies in the related art, although none of the technologies solve the problems in the art nor do they suggest a solution to the problems. Some of these technologies are now described.

Thin Film Magnetodielectric Materials (TFM)

Several documents have been published regarding TFMs. For example, U.S. Pat. No. 3,540,047 to Walser (incorporated herein by reference in its entirety) includes a description of TFMs. A TFM is constructed by alternating more than 200 thin (e.g., ˜1000 Angstrom) magnetic and dielectric layers (e.g., ˜400 Angstrom) that are deposited onto a smooth substrate, which is subjected to a two dimensional patterning process. This patterning process reduces the intrinsic permittivity of the magnetic layers so that the layers more closely match the as-deposited permeability of the layers. The purpose of the TFM is to match the impedance of the low frequency absorbing device over a narrow low frequency range (such as from 500 to 900 MHz). The matching results in a subsequent absorption of RF energy coupled with no reflection of RF energy in the resonance band. The bandwidth of such a device is about 0.25 Octave. A TFM can also be very pure, with an absorption depth of 30 dB or more, for example.

The concept of RF absorption via impedance matching has been described in several publications in the past. It is generally understood that many techniques can be utilized to produce narrow absorption performance. Walser has attempted to increase the performance band of TFMs by utilizing them at lower frequencies in the non-resonance bands. In addition, in the narrow resonance band, a TFM by its nature can be a negative index material (referred to herein as a “left-handed” material).

Unfortunately, the TFM technology demonstrates a theoretical phenomena that is not matched by the real world implementation of the device. A drawback of a TFM is that it suffers from a tremendously thick, glass-like, and fragile structure. As a consequence, TFM has a tendency to break, delaminate, and fall apart upon flexure, which are undesirable properties. Moreover, a TFM is difficult to use in practice, and the control of the resonance location requires a great deal of effort to make the as-deposited magnetic properties fit a very specific set of magnetic parameters.

The magnetic thin film constraints coupled with the physical complexity of the device requires that a very large capital investment in manufacturing equipment be spent in order to make a TFM material at a reasonable cost and volume. In addition, the TFM itself is very inefficient in its interaction with RF radiation, which necessitates additional material be deposited to achieve acceptable performance levels. This can lead to a tremendous weight penalty.

Negative Index Materials

Another type of material is a Negative Index Material, which is a type of material that is gaining a great deal of interest in the RF industry. An article entitled “Reversing Light with Negative Refraction” by John Pendry and David Smith, Physics Today, June 2004, (incorporated herein by reference in its entirety) describes Negative Index Materials.

Negative Index Materials are left-handed materials that are manufactured by creating an array of frequency scaled split ring and dipole oscillators. The split ring provides the magnetic component of the material, and the dipole provides the electrical contribution to the material. These physical elements are placed onto a honeycomb array such that the dimensionality of the elements creates a resonance in both the permeability and permittivity in the band of interest. By careful manufacturing, one can theoretically match the resonance frequency of both electrical and magnetic components. At the resonance matching point, the material exhibits a negative index of refraction.

Unfortunately, the resonance location of the material is very narrow, and exhibits high absorption. The general product target of left-handed materials is to manufacture lightweight, compact lenses. High absorption is a deleterious effect for that purpose. However, in the resonance band a left-handed material manufactured in this way with high absorption can act very much like a TFM. One problem, however, relates to closely matching both the electrical and magnetic components.

Another characteristic of left-handed constructs is that the resonance width is very narrow in a similar manner to TFM. Although the resonance frequency can be adjusted over a wider band (e.g., from ˜500 MHz to ˜30 GHz, for example) than for a TFM, the performance is no better. Indeed, the absorption performance can be generally far worse than TFM.

Another drawback is that the type of manufacture of a Negative Index Material does not lend itself to address higher or lower frequencies. The material is made up from an array of macro elements, which is expensive and difficult to manufacture in volume. Extension to lower frequencies necessitates a very heavy, impractically large array, while extension to higher frequencies necessitates a manufacturing technique that is currently unavailable. Many in the field are awaiting a method to extend this construct to higher frequencies.

Glancing Angle Thin Film Deposition

Another type of material is a Glancing Angle Thin Film Deposition material. This type of technology is described in a publication entitled “Optical Nanostructures Fabricated with Glancing Angle Deposition”, published in Vacuum and Coating Technology, by Matthew Hawkeye and Michael Brett, November 2005 (incorporated herein by reference in its entirety). This technology is targeted towards the manufacture of novel optical and infrared devices by altering the intrinsic permittivity of a material by imparting nanostructures into a device. The effect of devices manufactured in this way can in part resemble the performance of elements manufactured pursuant to the novel processes described below.

Unfortunately, elements generated pursuant to Glancing Angle Thin Film Deposition are inherently costly and difficult to manufacture. A key requirement for the manufacture of periodic arrays necessitates that the substrate be subject to prior treatment to locate the array of “seeds”. This seeding process utilizes integrated circuit (IC) lithographic technology but the element size is limited to the maximum size of IC substrates. While these seeds lead to the columnar periodic array, by its nature this array is a zero point solution towards the manufacture of any broad band device. With proper computer control it is possible to use glancing angle deposition to fabricate a device with a broad band structure in the infrared or optical bands, but with a very limited product scope. The process does not lend itself to the manufacture of devices with an operational band with wavelengths much longer than 5 microns. Moreover, the process is inherently low volume and costly.

In one aspect of the invention described herein, there is described a material, comprising layers of deposited substrates, coatings, or depositions onto spherical, spherical like, or particulate 0-D substrates. In another aspect, there is described a material, comprising layers of deposited substrates, coatings, or depositions onto 1-D substrates comprising fibers, non-fibrous or fibrous-like substrates. In another aspect, there is described a material, comprising layers of deposited substrates, coatings, or depositions on fibrous, non-fibrous or fibrous like 2-D substrates such as woven, knit, or non-woven fabrics. In another aspect, there is described a material, comprising layers of deposited substrates, coatings, or depositions onto fibrous, non-fibrous or fibrous like 3-D substrates. In another aspect, there is described a material, comprising layers of deposited substrates, coatings, or depositions onto 0-D, 1-D, 2-D, and 3-D textured substrates. In another aspect, there is described a material, comprising layers of deposited substrates, coatings, or depositions onto insitu textured 0-D, 1-D, 2-D, and 3-D substrates.

Other features and advantages should be apparent from the following description of various embodiments, which illustrate, by way of example, the principles of the invention.

### BRIEF DESCRIPTION OF THE DRAWINGS

FIG. 1 shows an exemplary cross section of an as deposited structure.

### DETAILED DESCRIPTION

Super Lattice Intrinsic Materials

There is now described a material referred to herein as a Super Lattice Intrinsic Material. The term Super Lattice Intrinsic Material and SLIM are trademarks of American Sputtering Technologies of San Diego, Calif.

A Super Lattice Intrinsic Material is manufactured pursuant to a far superior method of altering the intrinsic complex permittivity and complex permeability of materials than any of the techniques that exist in the prior art, including for the materials previously described. A method for manufacturing a Super Lattice Intrinsic Material incorporates in a non-obvious manner many of the salient features of all three previously-described materials methods, and combines them into one phenomenological procedure that lends itself to relatively high volume and relatively low cost manufacture.

The fabrication of a Super Lattice Intrinsic Material is vastly different than any of the prior art Moreover, there does not appear to be a limit in the scope of the product applications that can benefit from the Super Lattice Intrinsic Material technology. Super Lattice Intrinsic Materials can be manufactured pursuant to various embodiments that each provide a different set of complex electrical and complex magnetic parameters that satisfies the needs of a different product or any of a variety of specific products.

In an exemplary embodiment, a Super Lattice Intrinsic Material utilizes a coupling of an appropriate micro/macro structured substrate and a carefully designed group of as-deposited nanostructures that is unique in the art. Unlike any of the other methods of manufacture (including the methods described above), no specific material sets, thicknesses, or deposition technologies are required to create a Super Lattice Intrinsic Material array. Substrate texture can be provided either by prior or insitu processing, and the material depositions can be either uniform or non-uniform depending on the desired product parameters. An exemplary method of deposition to create a nanostructure is generally one of physical vapor deposition, PVD. However, plasma spray, CVD, plating or other thick film methods, for example, can work as well.

Super Lattice Intrinsic Material technology provides unique materials for a wide variety of applications including, but not limited to: microwave optics; Radar Absorbing Structures; Radar Absorbing materials; broad band, high dielectric constant, impedance matched materials; broad band, left handed RF, microwave, IR, and optical materials; high frequency super conducing materials; multi-state hysteretic static Random Access Memory; and quantum waveguide junctions to name a few. Virtually any type of product that utilizes electromagnetic properties can benefit from a properly designed Super Lattice Intrinsic Material.

Pursuant to a comparison of the performance of a broad band, high dielectric constant, impedance-matched Super Lattice Intrinsic Material to a TFM material, Applicant has observed the following performance figures:

Regarding TFM, a properly designed TFM can exhibit a deep (˜30 dB for example) absorption over a target frequency range ranging from about 500 to 900 MHz. The width of the absorption null is generally less than 100 MHz. The material can exhibit left-handed properties in the resonance null. At frequencies below the absorption band, the dielectric constant can be in excess of 100, but the impedance is typically higher than 3. At frequencies greater than the absorption band up to about 20 GHz the material is transparent. In the IR bands, the material exhibits a specular reflection of about 0.8. In the optical bands the exhibited color is silver metallic. In the IR and optical band, the TFM exhibits significant glint.

Regarding a Super Lattice Intrinsic Material, a properly designed Super Lattice Intrinsic Material array exhibits the following broad band properties: From less than 30 MHz to the cut on of the Broad Band Resonance (BBR) the material can have a dielectric constant ranging from about 30 to 300,000, with an impedance nearly equal to 1, for example.

Depending on the design, the BBR cuts on from between 500 MHz to 2 GHz, and extends to over 16 GHz (over 8 octaves wide), for example. In the BBR the dielectric constant ranges from about 30 to 3,000,000 with an impedance nearly equal to 1. The material can be either absorbing or non-absorbing and can be left-handed in the BBR. The material can exhibit a wide variety of hemispherical reflectances ranging from 0.1 to 0.98 across the IR bands. The Super Lattice Intrinsic Material can be made to exhibit a wide variety of optical colors, and these materials do not exhibit glint in the IR and optical bands.

A Super Lattice Intrinsic Material array is about 10% of the weight of a TFM, it is not fragile or brittle, and is easily incorporated into structures. A Super Lattice Intrinsic Material is far superior to TFM. A Super Lattice Intrinsic Material can find a wide variety of applications, including, for example, in Low Observable technologies, including but not limited to Artificial Dielectrics and size reduction due to their use; traveling wave reduction; Antennas; RF absorption, Long Wave IR, MidWave IR, Near IR, and optical signature reduction.

An exemplary manufacturing process of a broad band, high dielectric constant, impedance matched Super Lattice Intrinsic Material is now described. It should be appreciated that the following description is merely exemplary and that this disclosure is not limited to the following example.

The exemplary embodiment of manufacture begins with the concept of the macro/micro textured substrate, which is easily envisioned by considering a glass micro-balloon, such as of the type available from Corning. An acceptable, exemplary diameter of the balloon can range from less than 0.2 to more than 50 microns. While this particular substrate is a zero point example of the textured substrate concept, 1-D, 2-D, and 3-D extensions of this concept can also be utilized. Such substrates are generally available from many suppliers including Hexcell.

The nanostructured coatings in this exemplary embodiment are sputter deposited on to the substrate using, for example, an American Sputtering Systems MCS-1000 deposition tool supplied with Electri-Mag™ sputter sources. Both reactive and non-reactive DC sputtering techniques including but not requiring forbidden zone, high rate dielectric depositions can be used in the manufacture of these materials.

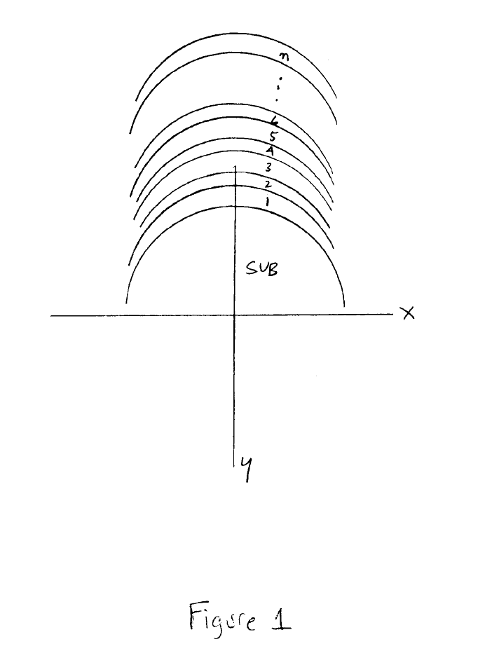

FIG. 1 shows an exemplary cross section of an as deposited structure onto the Corning glass microballoon (assuming suitable agitation of the substrate). The element has two axes of symmetry denoted as “x” and “y” in FIG. 1. It should be appreciated that such symmetry is not required for an operational Super Lattice Intrinsic Material array, but in this embodiment the symmetry is observed. The substrate is identified in FIG. 1 as “sub”, while the sputter deposited thin film layers 1 through n are also denoted in FIG. 1. The total number of layers “n” can range from 2 to more than 50, for example. In an exemplary embodiment, n is less than 50. Generally, layers 1, 3, 5, . . . n-1 comprise the same material, and layers 2, 4, 6, . . . n comprise another material. However it is not necessary that all even and all odd layers comprise the same material. It is not required that the odd layers be magnetic or metallic, and it is not required that the even layers be non-metallic.

It is desirable that each subsequent layer exhibits a sufficiently different intrinsic complex permittivity and complex permeability than the other layer. In the described embodiment the odd layers are metallic, and the even layers are dielectric, although this arrangement can be varied. The nominal thickness of the odd layers ranges from approximately 50 Angstroms to more than 1 micron, while the nominal thickness of the even layers ranges from approximately 5 Angstroms to more than 1 micron. It should be appreciated that other thicknesses can be used.

The nanostructure imparted onto the substrate dimensionality produces a continuously variable permittivity and permeability at each differential location in any given layer. The result is that the Super Lattice Intrinsic Material array exhibits a large number of closely aligned and overlapping resonance systems. If the material at each differential location on the array follows the Drude-Lorentz model, the resultant electromagnetic performance will consist of a superimposed grouping of allowed solutions at any given frequency. The nanostructure imparts a series of guided, tank circuits, and at certain frequencies the result is a Broad Band Resonance that can be left-handed. To those suitably schooled in the art alteration of the performance of the above Super Lattice Intrinsic Material array is accommodated by replication of the design in the wave propagation direction (the “y” direction in FIG. 1). This replication helps to establish the low frequency components of the super lattice. The aforementioned phenomenological approach can be applied to many different product applications.

Although embodiments of various methods and devices are described herein in detail with reference to certain versions, it should be appreciated that other versions, embodiments, methods of use, and combinations thereof are also possible. For example, any electromagnetic device that utilizes the phenomenological constructs or approach as described herein are included within the scope of the invention. Therefore the spirit and scope of the appended claims should not be limited to the description of the embodiments contained herein.

What is claimed is:

1. A material, comprising:
layers of deposited substrates, coatings, or depositions onto spherical, spherical like, or particulate 0-D substrates.

2. A material, comprising:
layers of deposited substrates, coatings, or depositions onto 1-D substrates comprising fibers, non-fibrous, or fibrous-like substrates.

3. A material, comprising:
layers of deposited substrates, coatings, or depositions on fibrous, non-fibrous or fibrous-like 2-D substrates.

4. A material, comprising:
layers of deposited substrates, coatings, or depositions onto fibrous, non-fibrous or fibrous like 3-D substrates.

5. A material, comprising:
layers of deposited substrates, coatings, or depositions onto 0-D, 1-D, 2-D, and 3-D textured substrates.

6. A material, comprising:
layers of deposited substrates, coatings, or depositions onto insitu textured 0-D, 1-D, 2-D, and 3-D substrates.

7. A material, comprising:
layers of deposited substrates, coatings, or depositions onto at least one of the group consisting of:
(a) spherical, spherical like, or particulate 0-D substrates;
(b) 1-D substrates comprising fibers, non-fibrous, or fibrous-like substrates;
(c) fibrous, non-fibrous or fibrous like 2-D substrate;
(d) fibrous, non-fibrous or fibrous like 3-D substrates;
(e) 0-D, 1-D, 2-D, and 3-D textured substrates; and
(f) insitu textured 0-D, 1-D, 2-D, and 3-D substrates.

8. A material as in claim 7, wherein the substrates, coatings, or depositions are comprised of alternating magnetic and dielectric materials.

9. A material as in claim 7, wherein the substrates, coatings, or depositions suitably alter the intrinsic or effective complex permittivity and complex intrinsic or effective permeability of materials.

10. A material as in claim 7, wherein the coating or deposition is comprised of alternating layers of metallic and dielectric materials.

11. A material as in claim 7, wherein the substrates, coatings, or depositions include alternating layers of two materials with sufficiently different intrinsic or effective complex permittivity and complex intrinsic or effective permeability.

12. A material as in claim 7, wherein the substrates, coatings, or depositions are comprised of any group of materials in any layered structure.

13. A material as in claim 7, wherein the substrates, coatings, or depositions replicate in the wave normal direction.

14. A material as in claim 7, wherein the material is part of a broad band, high dielectric constant, impedance matched material.

15. A material as in claim 7, wherein the material is part of a high frequency super conductor.

16. A material as in claim 7, wherein the material is part of a broad band left handed RF material.

17. A material as in claim 7, wherein the material is part of a broad band left hand IR material.

18. A material as in claim 7, wherein the material is part of a broad band left handed optical material.

19. A material as in claim 7, wherein the material is part of a multi-state hysteretic static RAM.

20. A material as in claim 7, wherein the material is part of a quantum waveguide junction.

21. A material as in claim 7, wherein the material is part of a Radar Absorbing Structure.

22. A material as in claim 7, wherein the material is part of a Radar Absorbing Material.

23. A material as in claim 7, wherein the material is part of a microwave/optical material.

24. A material as in claim 7, wherein the substrates, coatings, or depositions are uniform over a 2-D area.

25. A material as in claim 7, wherein the substrates, coatings, or depositions are non-uniform over a 2-D area.

26. A material as in claim 7, wherein the alternating layers of substrates, coatings, or depositions need not comprise the same material.

27. A material as in claim 7, wherein the alternating layers of substrates, coatings, or depositions can be either magnetic, metallic, or dielectric in any order.

28. A material as in claim 7, wherein the deposited substrates, coatings, or depositions on fibrous, non-fibrous or fibrous like 2-D substrates are selected from the group consisting of one of at least woven, knit, or non-woven fabrics.

29. A material as in claims 3, wherein the material is used to improve the performance or reduce the size of an antenna.

30. A material as in claim 29, wherein the antenna is an RF or microwave antenna.
